(19) United States
(12) Patent Application Publication
(10) Pub. No.: US 2016/0246440 A1
(43) Pub. Date: Aug. 25, 2016

(54) ELECTRICAL ACTUATOR FOR TOUCH SCREEN EMULATION

(71) Applicant: Arya A. Ardakani, Mission Viejo, CA (US)

(72) Inventor: Arya A. Ardakani, Mission Viejo, CA (US)

(21) Appl. No.: 15/051,611

(22) Filed: Feb. 23, 2016

Related U.S. Application Data
(60) Provisional application No. 62/119,692, filed on Feb. 23, 2015.

(51) Int. Cl. G06F 3/041; G06F 3/01; G06F 3/044

(52) U.S. Cl. CPC G06F 3/0416; G06F 3/044; G06F 3/017; G06F 2203/04102

(57) ABSTRACT

The subject disclosure relates to systems and methods for emulating touch-based inputs on a touch screen of a mobile computing device, such as a tablet computer or smart phone device. In some embodiments of the technology, an actuator pad can include an actuation layer comprising a matrix of transistors and a conductive layer comprising a plurality of conductive pads. In some embodiments, the actuation layer can drive a signal to the conductive layer to induce capacitive changes necessary to emulate a user's interaction onto an underlying touch-screen of a mobile computing device.

### CROSS REFERENCE TO RELATED APPLICATIONS

This application claims priority to U.S. Provisional Application No. 62/119,692, entitled “ELECTRICAL ACTUATOR FOR TOUCH-SCREEN EMULATION,” filed Feb. 23, 2015, which is incorporated herein by reference in its entirety.

### BACKGROUND

1. Technical Field

The subject technology relates to systems and methods for emulating touch on a touch-screen, and in particular, for porting display and touch-functionality of a capacitive touch-screen to a secondary display device.

2. Introduction

As the ubiquity of mobile device use increases, so does the demand for protective cases and connectivity accessories, for example, to facilitate the projecting and/or transferring/transmitting of mobile device displays. In some conventional solutions, Universal Serial Bus (USB), or display port cables are used to transfer a display from a mobile device (e.g., a smartphone or tablet computer), to a secondary device, such as an extended monitor.

### SUMMARY

The following presents a simplified summary of one or more embodiments in order to provide a basic understanding of such embodiments. This summary is not an extensive overview of all contemplated embodiments, and is intended to neither identify key or critical elements of all embodiments nor delineate the scope of any or all embodiments. Its sole purpose is to present some concepts of one or more embodiments in a simplified form as a prelude to the more detailed description that is presented later.

In some aspects, the disclosed subject matter relates to a touch-screen actuation pad configured to emulate an interaction with a touch-screen surface, the touch-screen actuation pad including an actuation layer including a matrix of transistors, and a conductive layer comprising a plurality of conductive pads, wherein each conductive pad is electrically coupled with a respective transistor on the actuation layer, and wherein the conductive layer is configured for provide an engagement between the plurality of conductive pads and the touch-screen surface. In some implementations, each transistor can be configured to transmit a driving signal to a corresponding conductive pad of the conductive layer to emulate an engagement with the touch-screen surface.

In another aspect, the disclosed subject matter relates to a method for emulating a user's interaction with a target touch-screen surface, the method including steps for actuating one or more transistors in an actuator comprising a matrix of transistors, wherein actuation of the one or more transistors causes transmission of a driving signal to one or more conductive pads located on a target touch-screen surface for emulating a user's interaction with the target touch-screen surface at a corresponding location.

### BRIEF DESCRIPTION OF THE DRAWINGS

It is understood that other configurations of the subject technology will become readily apparent to those skilled in the art from the following detailed description, wherein various configurations of the subject technology are shown and described by way of illustration. The subject technology is capable of other and different configurations and its several details are capable of modification in various respects without departing from the scope of the subject technology. Accordingly, the detailed description and drawings are to be regarded as illustrative and not restrictive in nature.

Certain features of the subject technology are set forth below. However, the accompanying drawings, which are included to provide further understanding, illustrate disclosed aspects and together with the description serve to explain the principles of the subject technology. In the drawings:

FIG. 1 illustrates an example of a touch-screen actuation pad 100 in an active embodiment;

FIG. 2 illustrates an example schematic diagram of an interconnection between transistors 102 of actuation layer 110 and conductive pad 108 of conductive layer 112;

FIG. 3 illustrates an example method of driving conductive pads of touch-screen actuation pad 100 in an active embodiment;

FIG. 4 illustrates a touch-screen actuation pad 100 with multiple digitizing layers in an active embodiment;

FIG. 5 illustrates an example exploded view of an actuation substrate layer or receiving (Rx) substrate layer 500 in a passive embodiment;

FIG. 6 illustrates an example exploded view of a foldable conductive substrate layer or transmitting (Tx) substrate layer 600 in a passive embodiment;

FIG. 7 illustrates an example of the Rx substrate layer of FIG. 5 in a passive embodiment that has been folded for coupling with a touch-screen of a mobile computing device;

FIG. 8 illustrates an example folded configuration of actuation substrate layer and conductive substrate layer in a passive embodiment and example cut-away perspective view of the folded configuration;

FIG. 9 illustrates an example implementation of a touch-screen actuation pad, as used in conjunction with a converter tablet (CT);

FIG. 10 illustrates an example implementation of a touch-screen actuation device detecting touchless gestures and emulating the detected contactless gestures onto the smaller mobile computing device through example CT device 902;

FIGS. 11A & 11B illustrate example system embodiments.

### DETAILED DESCRIPTION

The detailed description set forth below is intended as a description of various configurations of the subject technology and is not intended to represent the only configurations in which the subject technology can be practiced. The appended drawings are incorporated herein and constitute a part of the detailed description. The detailed description includes specific details for the purpose of providing a more thorough understanding of the subject technology. However, it will be clear and apparent that the subject technology is not limited to the specific details set forth herein and may be practiced without these details. In some instances, structures and components are shown in block diagram form in order to avoid obscuring the concepts of the subject technology.

Aspects of the subject technology provide systems and methods for emulating touch on a touch-screen (such as a capacitive touch-screen), using a touch-screen actuation pad. As discussed in further detail below, aspects of the subject technology also include systems and methods for emulating a first touch-screen of a first mobile computing device on a secondary touch-screen of a second mobile computing device. In such implementations, a display of the first touch-screen can be reproduced on a second touch-screen, whereas signaling (e.g. capacitive signaling) received on the second touch-screen device is conveyed to the first touch-screen. As discussed in further detail below, a touch-screen actuation pad (also “actuation pad”) can be used to emulate the touch-screen of a mobile device on a larger touch-based display, such that touch functionality seamlessly transfers between a source mobile device and a secondary (emulated) display.

In certain aspects, a touch-screen actuation pad can be placed over the surface of a touch-screen, such as that of a mobile device (e.g., a smartphone/tablet computer display). By altering the electrical properties of the touch-screen actuation pad, capacitive changes can be induced in the underlying touch-screen, simulating conventional user contact with the display surface. As such, an actuation pad can be used in conjunction with a secondary capacitive touch screen, for example, to convey signaling produced by user interaction with the secondary touch-screen to a touch-screen of the mobile device, via the actuation pad.

In some implementations, the touch-screen actuation pad can be used to facilitate the emulation of the display and touch-screen input of a mobile device touch-screen, for example, as part of a converter tablet (CT) device. In such implementations, the CT device may be configured to retain a smaller device containing a touch-screen (e.g., a smartphone or tablet computer). Using an actuator pad that contacts the touch-screen of the smaller device, the CT device can project touch-functionality onto a larger screen (e.g., an outer screen of the CT device). Similarly, a video output of the touch-screen of the mobile device can be projected and/or transferred onto the larger outer screen of the CT device. As such, display and touch-functionality may be transferred from the mobile device to the retaining CT device.

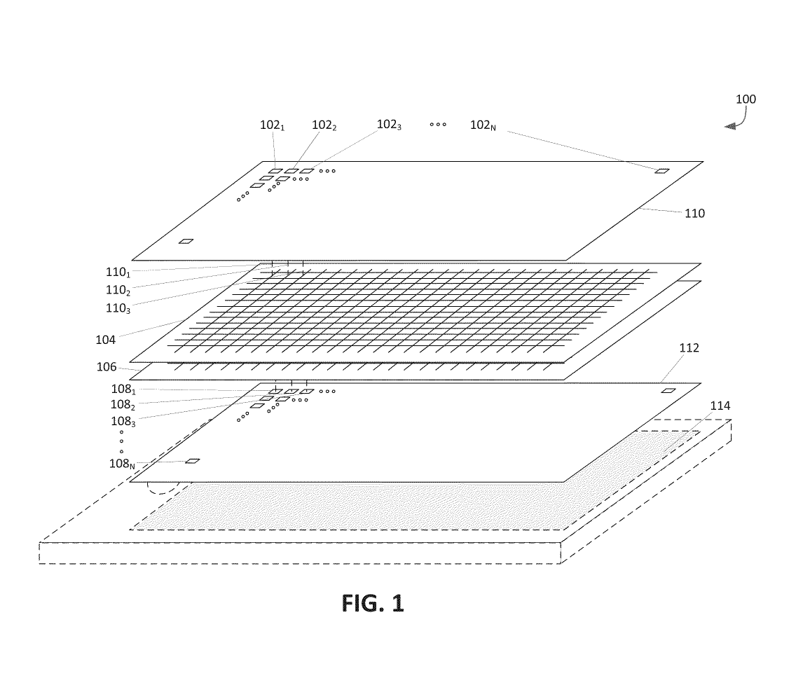

FIG. 1 illustrates an example of a touch-screen actuation pad 100 in an active embodiment. Touch-screen actuation pad can include multiple layers. As shown in FIG. 1, the touch-screen actuation pad 100 can include actuation layer 110, routing layers 104 and 106 and conductive layer 112, which includes one or more conductive pads 108. Although the example of FIG. 1 illustrates an implementation with two routing layers, a greater (or fewer) number of routing layers may be implemented, without departing from the scope of the technology.

As illustrated, actuation layer 102 can include a plurality of transistors 102 (102₁, 102₂, 102₃, . . . , 102_{N}). In some embodiments transistors 102 can be laid out in a matrix formation, e.g., where each transistor is addressed at a predetermined row/column.

It is understood that a variety of transistor types may be implemented, so long as each transistor is configured to transmit a driving signal to a respective conductive pad, e.g., on conductive layer 112. For example, each transistor in the matrix of transistors can be a MOSFET, FET, or BJT transistor. Routing layer 104 and 106 both house routing lines configured to transmit the driving signal from actuation layer 102 to conductive layer 108. Conductive layer 112 includes conductive pads 108 (e.g., 108₁, 108₂, 108₃, . . . , 108_{N}). It is understood that conductive pads 108 can include one or more of a variety of conductive materials (e.g. copper, aluminum, etc.). A material composition of the conductive pad may be chosen based on the corresponding driving signal. That is, an impedance of the conductive pad may be matched with the driving signal so that receipt of the driving signal induces capacitive changes in the pad that are similar to capacitive changes induced in a capacitive touch-screen display resulting from user interaction.

In operation, each transistor 102 in actuation layer 110 is electrically connected to a corresponding conductive pad 108 in conductive layer 112, through routing layers 104 and 106. In turn, conductive layer 112 is engaged with touch screen 114 (e.g. a capacitive touch-screen) of a computing device. Each conductive pad 108 engages touch-screen 114 at a corresponding location on the surface of touch-screen 114. As noted above, transistors 102 on actuation layer 110 can be arranged in a grid or matrix formation (rows and columns). As such, each transistor 102 is electrically connected to a corresponding conductive pad 108, conductive pads 108 can be similarly laid out in the same grid formation as each transistor 102. Furthermore, each conductive pad 108 can be similarly engaged with touch-screen 114 in a similar grid formation as transistor 102.

In some embodiments, touch-screen actuation pad 100 can be placed over the surface of a touch-screen of a mobile computing device (e.g. a smartphone/tablet computer display) and used to emulate a user's touch/interaction with the touch-screen. For instance, actuation layer 110 can be configured to receive a signal from a second device (e.g. another touch-screen or smartphone/tablet/desktop/laptop, etc.) and drive a signal through routing layers 104 and 106 to change the capacitance of conductive layer 112. The capacitive change in conductive layer 112 effectively emulates a user's touch onto touch-screen 114.

By way of further example, transistor 102₁ is electrically coupled to corresponding conductive pad 108₁, e.g., through routing layers 104 and 106. Additionally, conductive pad 108₁ engages with touch-screen 114 at a specific location of touch-screen 114. When transistor 102₁ is actuated (e.g., by a second device or control system), transistor 102₁ drives a signal to routing layers 104 and 106. As a result changes the capacitance of conductive pad 108₁. Since 108₁ engages touch-screen 114 at a specific location, the change in capacitance of conductive pad 108₁ simulates a user's touch/interaction at that specific location of touch-screen 114.

In some embodiments, using the above described principles, the touch-screen actuation pad can be used to emulate a user's interaction with a first touch screen (e.g., of a first mobile computing device) onto a second touch-screen, e.g., of a second mobile computing device. Additionally, in such implementations, with the aid of the touch-screen actuation pad, the first touch-screen can also reproduce the display of the second touch-screen to convey signaling (e.g. capacitive signaling) received on the second touch-screen device on the first touch-screen. This can be achieved with an electronic connection between the first mobile computing device and the second mobile computing device, either through or independent from the touch-screen actuation pad.

In other embodiments, touch-screen actuation pad 100 can include a microcontroller or processor configured to monitor and control transistors 102 of actuation layer 110. For example, a microcontroller or processor (not illustrated)can be electrically connected to transistors 102 of actuation layer 110 in order to control which transistor 102 of actuation layer 110 is activated. As discussed in further detail below, touch-screen actuation pad 100 can be controlled and monitored remotely. For example, the microcontroller or processor can be electronically coupled to an antenna e.g. a near field communication (NFC) antenna. As such, a touch-screen mobile computing device (e.g. a smart phone, a tablet, a laptop, a desktop, etc.) can remotely monitor and control the matrix of transistors 102 of touch-screen actuation pad 100 through the antenna, thereby emulating a user's engagement with a corresponding touch screen.

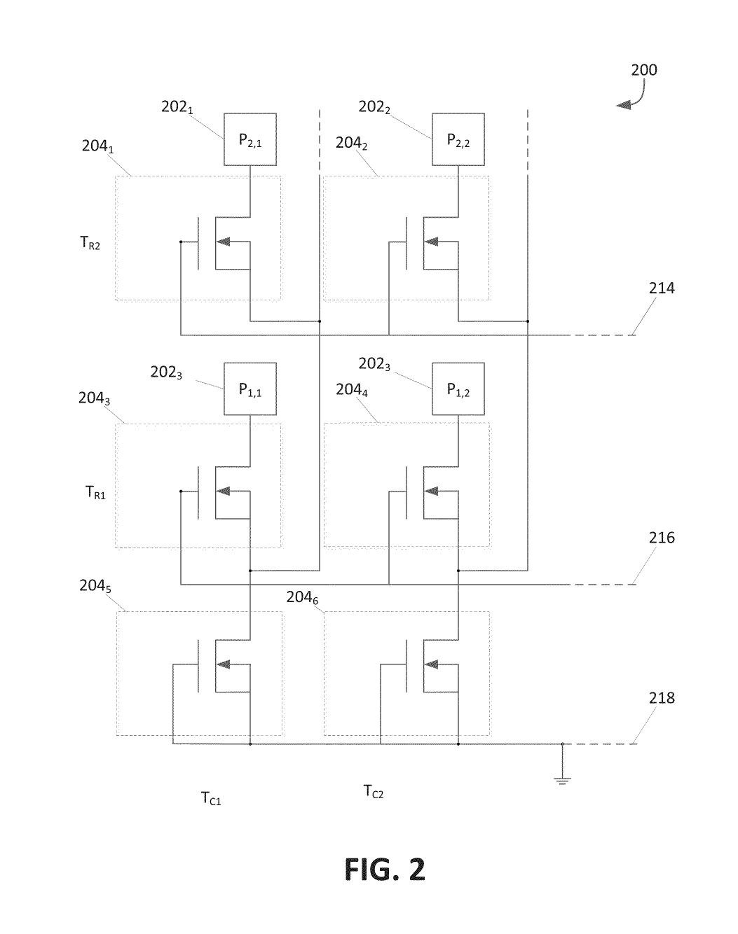

FIG. 2 illustrates an example schematic diagram of an interconnection between transistors 102 of actuation layer 110 and conductive pad 108 of conductive layer 112. In the example schematic 200, transistors 204 (204₁, 204₂, 204₃, 204₄, 204₅, 204₆) correspond to transistors 102 of FIG. 1. Additionally, conductive pads 202 (202₁, 202₂, 202₃, 202₄, 202₅, 202₆) correspond with conductive pads 108 of FIG. 1.

In some embodiments, each transistor 204 can have its source connected to ground, its gate connected to an input line (e.g. 214, 216, or 218) and its drain connected to a corresponding conductive pad 202. Input lines 214, 216 and 218 receive signals to activate a specific transistor-conductive pad combination (e.g. transistor 204₃ and corresponding conductive pad 202₃).

As described above, each transistor of the actuation layer can be electronically connected to a corresponding conductive pad of the conductive layer in a grid formation. For example, as illustrated in FIG. 2, transistors 204 and corresponding conductive pads are configured to be in a grid formation. For instance, transistor 204₃ is located at the first row (T_{R1}) and first column (T_{C1}) and the corresponding conductive pad 202₃ is also located at the first row and first column (P_{1,1}).

In some aspects, grounding the source of a transistor of the actuation layer while the gate of the transistor is active can drive the corresponding conductive pad of conductive layer. As such, when the signal is received by the actuation pad, the gates of transistors 204 are activated.

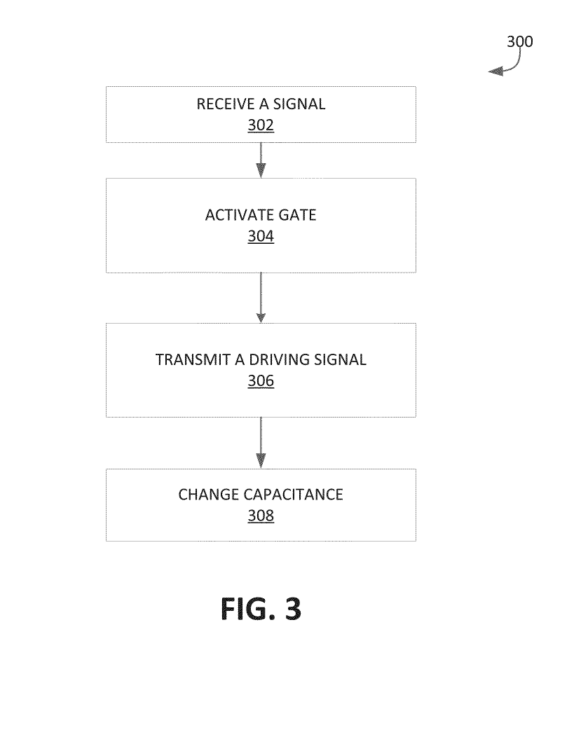

An example method of driving conductive pads (e.g. 202) of the conductive layer is illustrated in FIG. 3. Example method 300 begins at step 302, where the gate of a transistor receives a signal. For example, the gate of transistor 204₃ receives a capacitance signal at line 216. At step 304, the received signal activates the gate of the transistor. Activating the gate of the transistor can be achieved when the voltage of the signal is larger than the gate threshold voltage of the transistor. For example, as illustrated in FIG. 2, the gate of transistor 204₃ is activated when the voltage of the signal is larger than voltage threshold of the gate of transistor 204₃.

In some embodiments, instead of activating the gate of the transistor, modulation of the gate of the transistor can drive the corresponding conductive pad. Various modulation schemes may be used, without departing from the scope of the invention. By way of example, a pulse width modulation (PWM) scheme may be used to activate a particular pad at an address corresponding with a touch-screen location where simulated touch is desired.

At step 306, activating the gate causes the transistor to drive a signal to a corresponding conductive pad and in turn, at step 308 changes the capacitance of the conductive pad. In turn, the change in capacitance of the conductive pad can emulate the user's touch on the underlying touch-screen. For example, as illustrated in FIG. 2, activating the gate of transistor 204₃ causes conductive pad 202₃ to become electrically grounded. This change in capacitance can be detected by an underlying touch-screen and therefore the user's touch/interaction can be emulated on the underlying touch-screen. Depending on where conductive pad 202₃ engages with the underlying touch-screen, conductive pad 202₃ simulates a touch of a user at the corresponding location of the touch-screen of a mobile computing device.

As noted above, in some embodiments, there can be one or more routing layers between the actuation layer and the conductive layer. As such in some embodiments, the transistor is electronically connected to the corresponding conductive pad through one or more routing layers (e.g. routing layers 104 and 106). Thus, the transmitted driving signal can cause a change in conductance of the routing lines of the routing layers. The transmitted driving signal can cause a change in conductance of the routing layers. In turn, the change in conductance of routing layers can cause capacitive changes of conductive layer.

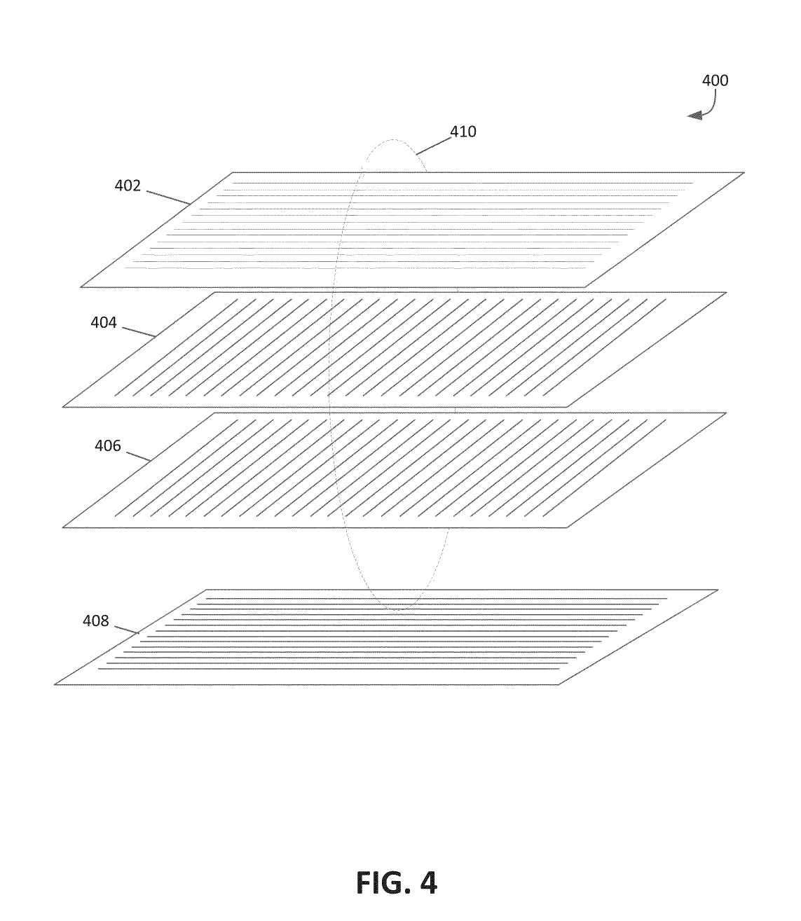

In another active configuration, touch-screen actuation pad 100 can include multiple digitizing layers instead of a matrix of transistors and corresponding conductive pads. Each digitizing layer having either a receiving (“Rx”) digitizer lines or transmitting (“Tx”) digitizer lines. For example, FIG. 4 illustrates a touch-screen actuation pad 100 with multiple digitizing layers in an active embodiment.

As shown in FIG. 4, the actuation pad includes receiving (or actuation) layer 402 and transmitting (or conductive) layer 404. Environment 400 also includes a mobile device's touch screen layers 406 and 408. As illustrated in FIG. 4, transmitting layer 402 and touch-screen layer 406 include transmit digitizing lines, and receiving layer 404 and touch-screen layer 408 include receive digitizing lines.

The receiving and transmitting layers 402 and 404 are electromagnetically (EM) coupled with the Tx touch-screen layer 406 via electromagnetic field 410. Furthermore, the digitizing lines of touch-screen actuating pad (402 and 404) the touch-screen layers (406 and 408) are aligned.

In this configuration, receiving layer 402 and transmitting layer 404 can be configured similar to actuation layer 110 and conducting layer 112 of FIG. 1. For instance, the Rx lines of receiving layer 404 and Tx lines of transmitting layer 406 can be actively controlled. For example, a signal from a microcontroller or processor (e.g., System on a Chip) can be received by receiving layer 404. In turn the received signal can alter the capacitive properties (e.g. current changes of EM field 410) of various Rx/Tx lines between receiving layer 402 and transmitting layer 404. As such, by changing the capacitive properties between the Rx/Tx lines a user's touch on the underlying touch-screen can be simulated at a location where corresponding Rx/Tx lines intersect, e.g., touch-screen layers 406 and 408. That is, a simulated touch can be induced onto a surface of an underlying touch-screen, at a corresponding location via an electromagnetic coupling formed between Rx/Tx lines of touch-screen actuation pad 100 (receiving layer 402 and transmitting layer 404) and corresponding Rx/Tx lines that form the touch-screen (touch-screen layers 406 and 406) of an underlying mobile computing device.

In other implementations, the touch-screen actuating pad made up of multiple foldable substrate layers that can passively (i.e. without the use of microcontrollers and/or processors for actively altering the Rx lines of one layer and the Tx lines of the other layer) emulate a user's touch on an underlying touch-screen of a mobile computing device. The foldable touch-screen actuation pad 100 can then be placed on top of a touch-screen of a mobile computing device. Thus, using the above described techniques, user interactions with the passive actuation pad are communicated to a corresponding location on the surface of the underlying capacitive-touch screen.

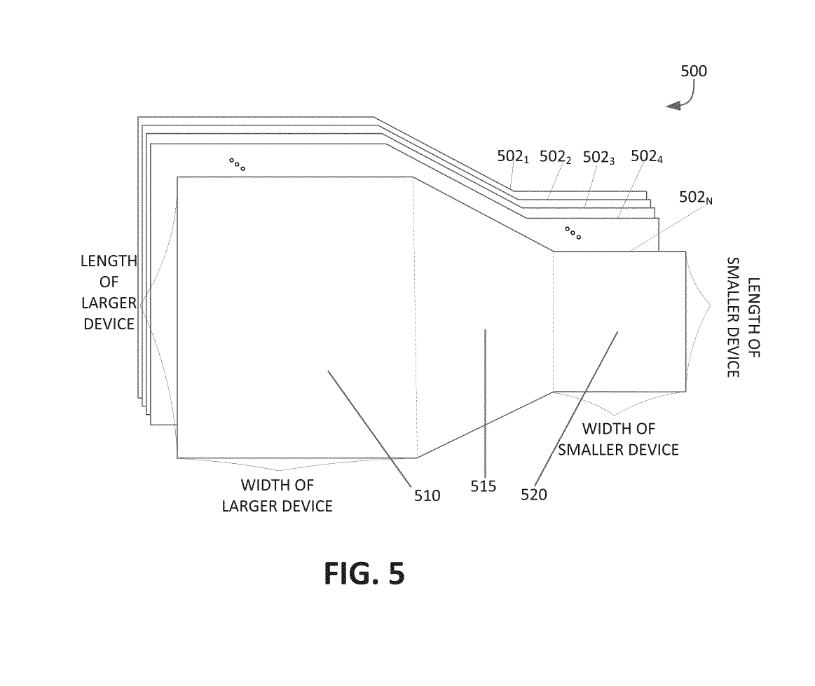

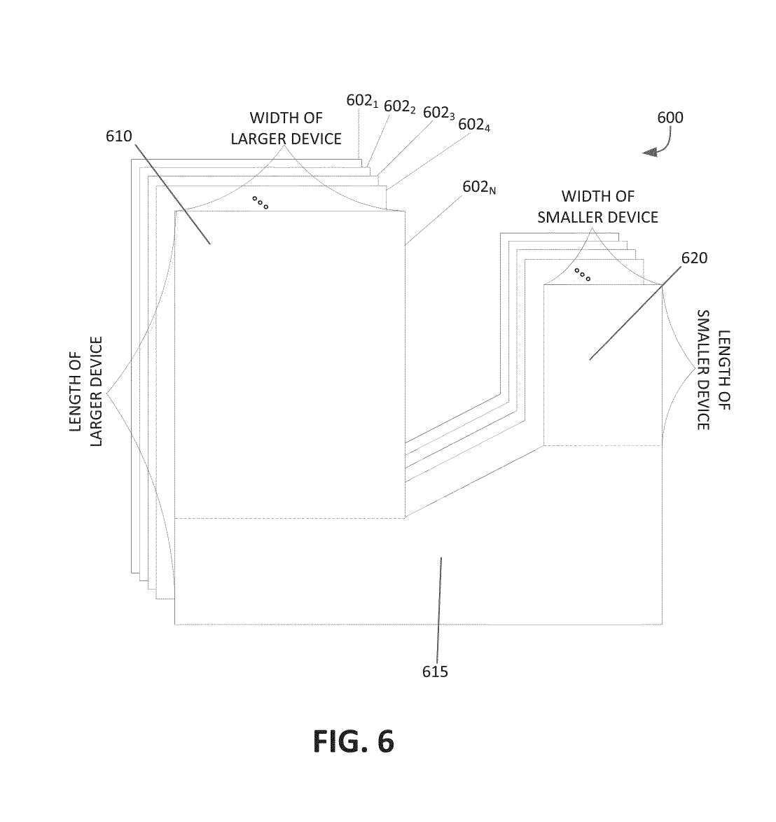

FIGS. 5 and 6 illustrate an example construct of foldable substrate layers that make up a touch-screen actuation pad in a passive embodiment. FIG. 5 illustrates an example exploded view of an actuation substrate layer or receiving (Rx) substrate layer 500 in a passive embodiment. Actuation substrate layer or Rx substrate layer 500 includes multiple Rx lines 502 (502₁, 502₂, 502₃, 502₄, . . . , 502_{N}), for example, embedded in a transparent and flexible substrate. In some configurations, as illustrated in FIG. 5, Rx substrate layer 500 can accommodate a touch-screen of a smaller mobile computing device and a touch-screen of a larger mobile computing device. For example Rx substrate layer 500 includes portion 510 configured to engage a touch-screen of a larger mobile computing device, portion 520 configured to engage a touch-screen of a smaller mobile computing device and portion 515 configured to connected portion 510 and portion 520. For instance, as illustrated in FIG. 5, on one end, Rx substrate layer 500 can accommodate the length and width of the touch screen of a smaller mobile computing device. On the other end, Rx substrate 500 can accommodate the length and width of the touch-screen of a larger mobile computing device.

FIG. 6 illustrates an example exploded view of a foldable conductive substrate layer or transmitting (Tx) substrate layer 600 in a passive embodiment. Conductive layer or Tx substrate layer 600 includes multiple transparent Tx lines 602 (602₁, 602₂, 602₃, 602₄, . . . , 602_{N}). In some configurations, Tx substrate layer 600 can accommodate a touch-screen of a smaller mobile computing device and a touch-screen of a larger mobile computing device. For example Rx substrate layer 600 includes portion 610 configured to engage a touch-screen of a larger mobile computing device, portion 620 configured to engage a touch-screen of a smaller mobile computing device and portion 615 configured to connected portion 610 and portion 620. For instance, as illustrated in FIG. 6, on one end, Tx substrate layer 600 can accommodate the length and width of the touch-screen of a smaller mobile computing device. On the other end, Rx substrate 600 can accommodate the length and width of the touch-screen of a larger mobile computing device.

Each actuation substrate layer and conductive substrate layer (e.g. Rx substrate layer and Tx substrate layer of FIG. 5 and) can be folded for cooperation over a touch-screen for which a user's touch can be emulated (e.g. by engaging the Tx layer of the foldable touch-screen actuation pad 100 to the touch-screen of a computing device). The Rx digitizing lines of the Rx substrate layer and Tx digitizing lines of the Tx substrate layer may be comprised of a conductive material (e.g. copper wire). As such, the Tx and Rx substrate layer can facilitate an EM coupling between active Rx/Tx lines of an underlying capacitive touch screen. It is through the EM coupling, that any capacitive changes induced in the actuation pad Rx and Tx lines (e.g., through touch by a user), are communicated to the surface of the touch-screen of a computing device. Thus, user interactions with the passive touch-screen actuation pad 100 are communicated to a corresponding location on the surface of the underlying touch screen of a mobile computing device.

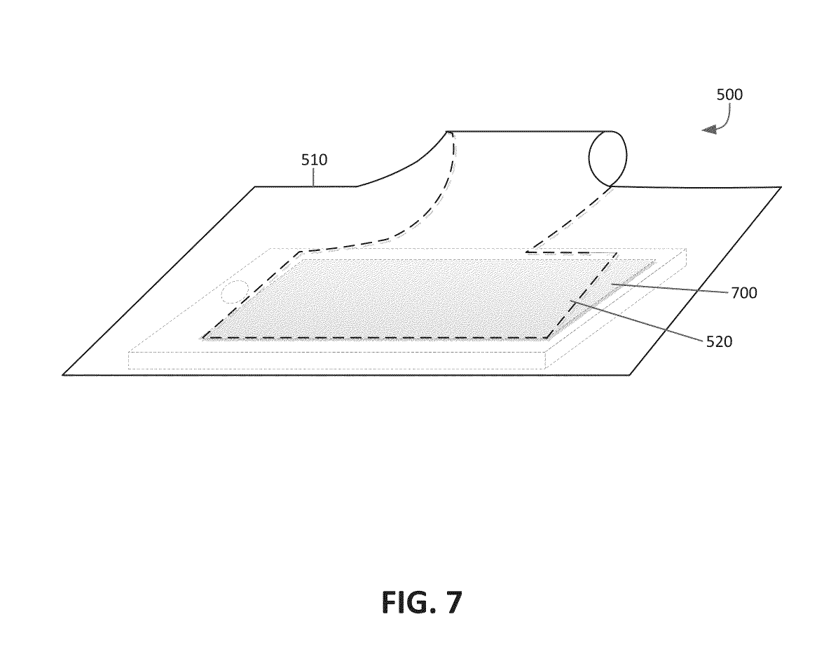

FIG. 7 illustrates an example of the Rx substrate layer of FIG. 5 in a passive embodiment that has been folded for coupling with a touch-screen of a mobile computing device. Rx substrate layer 500 is foldable and includes portion 510 and portion 520. As illustrated in FIG. 7, Rx substrate layer 500 has portion 510 configured to engage the touch-screen of a larger mobile computing device. Additionally, Rx substrate layer 500 has portion 520 configured to engage the touch-screen of a smaller device—here shown as touch-screen 700. In such a configuration, the user can emulate their interaction with the touch-screen of a larger mobile computing device onto the touch-screen of a smaller mobile computing device, while being able to view the results of their interaction on the touch-screen of the larger mobile computing device.

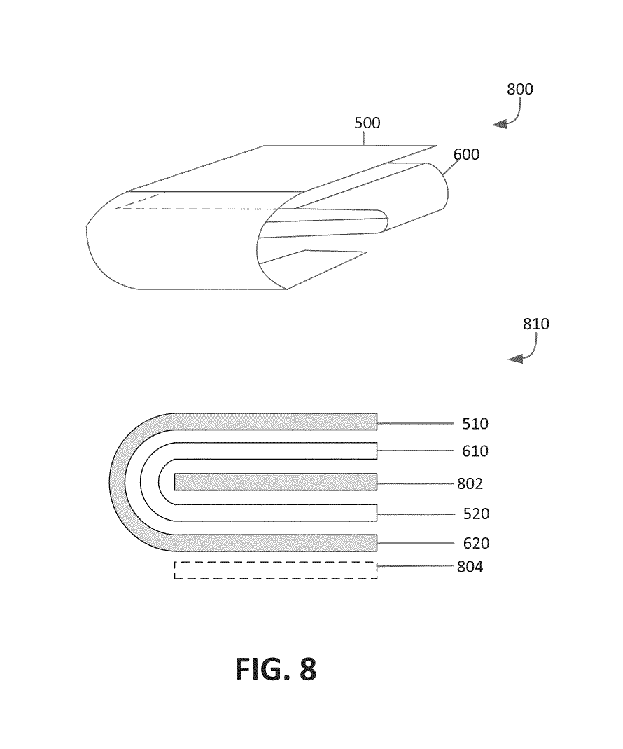

FIG. 8 illustrates an example folded configuration of an actuation substrate layer and conductive substrate layer in a passive embodiment and example cut-away perspective view of the folded configuration. Example configuration 800 illustrates Rx substrate illustrated in FIG. 5 and Tx substrate layer illustrated in FIG. 6 folded together. Cut-away perspective 810 illustrates a cut-away perspective of example configuration 800 when Tx substrate layer 600 and Rx substrate layer 500 engage a touch-screen of a larger mobile computing device and a touch-screen of a smaller mobile computing device. For instance as illustrate in FIG. 8, portion 510 of Rx substrate layer 500 engages with portion 610 of Tx substrate layer 600, which in turn engages with touch-screen 802 of a larger mobile computing device. Additionally, portion 520 of Rx substrate layer 500 engages with portion 620 of Tx substrate layer 600, which in turn engages with touch-screen 804 of a smaller mobile computing device. In some embodiments, Rx substrate layer 500 and Rx substrate layer 600 are transparent. As such a user can interact with and view touch-screen 802 of a larger mobile computing device, such that, using the above described techniques, all user interactions can be conveyed to touch-screen 804 of the smaller mobile computing device.

In some embodiments, using the above describe techniques, a user can emulate their interaction with touch screen 802 of the larger mobile computing device to touch screen 804 of the smaller mobile computing device. In such implementations, a display of touch screen 804 of the smaller mobile computing device can be reproduced on touch-screen 802 of the larger mobile computing device. Additionally, signaling (e.g. capacitive signaling) received on touch-screen 802 of the larger mobile computing device can then be conveyed to touch screen 804 of the smaller mobile computing device. As discussed above, a touch-screen actuation pad 100 can be used to emulate touch screen 804 of the smaller mobile computing device on touch-screen 802 of the larger mobile computing device, such that touch functionality seamlessly transfers between the smaller mobile computing device (or source device) and the larger mobile computing device (or secondary/emulated display)

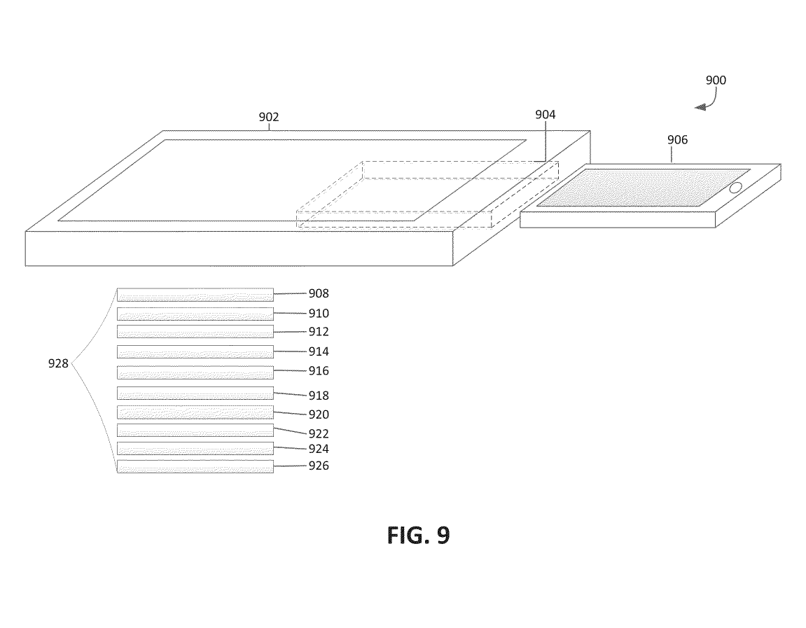

FIG. 9 illustrates an example active implementation of a touch-screen actuation pad, as used in conjunction with a converter tablet (CT). In the example of FIG. 9, CT device 902 is configured to house mobile computing device 906 (e.g., the smartphone) in slot 904. Slot 904 includes an example of multiple protective and functional layers within slot 904. An example of the cut-away perspective of when mobile computing device 906 is inserted into slot 904 is illustrated with cutaway perspective 928. As illustrated in FIG. 9, cutaway perspective 928 of slot 904 includes glass layer 908, CT touch digitizer layer 910, CT LCD layer 912 actuation layer 914, and CT back body layer 926. Additionally cut-away perspective 928 also illustrates the layers of inserted mobile computing device 906 with respect to the multiple protective and functional layers (mobile computing device glass layer 916, mobile computing device touch digitizer layer 918, mobile computing device LCD layer 920, mobile computing device circuitry layer 922, and mobile computing device back body layer 924).

Using the above described techniques, CT device 902 can provide a mechanical and/or electromagnetic coupling between a touch-screen actuation pad 100 of CT device 902 and mobile computing device 906. For instance, when mobile computing device 906 is inserted into slot 904, actuation layer 914 engages with the mobile computing device glass layer 916 and can EM couple with mobile computing device touch digitizer layer 918.

In some implementations, using the above describe techniques, a CT device can be used to facilitate the emulation of the display and touch-screen input of a touch-screen mobile computing device. For example, when actuation layer 914 of CT device 902 engages with the inserted mobile computing device 906 in slot 904, CT device 902 can project touch-functionality onto the screen of CT device 902. Similarly, a video output of the touch-screen of mobile device 906 can be projected and/or transferred onto the larger outer screen of CT device 902. As such, display and touch-functionality may be transferred from mobile computing device 906 to CT device 902.

In some embodiments, CT touch digitizer layer 912 and actuator 914 can implemented passively. For example, instead of the active configuration illustrated in cutaway perspective 928, the actuation layer 914 includes multiple substrate layers folded together (e.g. similar to Rx substrate and Tx substrate layers illustrated in FIGS. 5, 6 and 8).

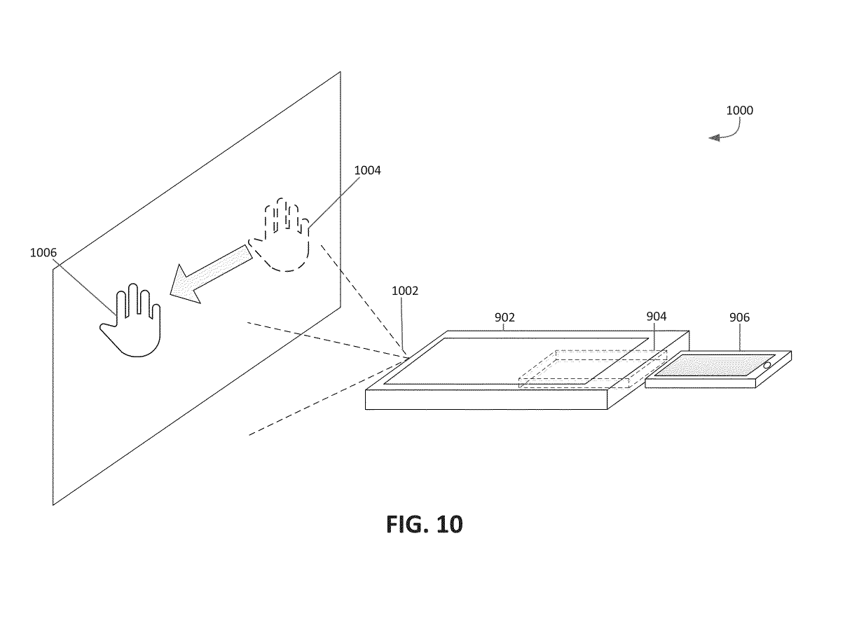

FIG. 10 illustrates an example implementation of a touch-screen actuation device configured for detecting user gestures and emulating a user's interaction with a touch-screen of a mobile computing device via a CT device 902. Example environment 1000 includes projector CT device 902 with slot 904 and mobile computing device 906. Projector CT device 902 can include gesture detection device 1004 (e.g. one or more cameras, infra-red (IR) sensors, microwave sensor, ultrasonic sensor, radio-wave sensor, etc.) and a projector. Gesture detection device 902 can be configured to detect contactless gestures (e.g. swipe left, swipe right, swipe up, swipe down, pumping, clapping, etc. . . ). For example, as illustrated in FIG. 10, a user can swipe left (moving their hand left to right or from position 1004 to position 1006) and as such, the contactless gesture can be detected by gesture detection device 902. The projector of projector CT device 902, is configured to project the display of the small mobile computing device 906 and any interactions conveyed to small mobile computing device 906 from CT device 902.

In this example implementation and using the above describe techniques, gestures or commands (e.g. swipe left) can be detected by gesture detection device 1002. The detected gestures can then be conveyed into electrical signaling. CT device 902 through actuator layer 914 (not shown in FIG. 10) can emulate the user's gestures onto the touch screen of mobile computing device 906. Furthermore, the projector of CT device 902 can project the display of small mobile computing device 906 and emulate a user's gestures on the projected display (captured by the gesture detection device 1002) to the small mobile computing device 906. As such the user can interact with small computing device 906 through the projected display.

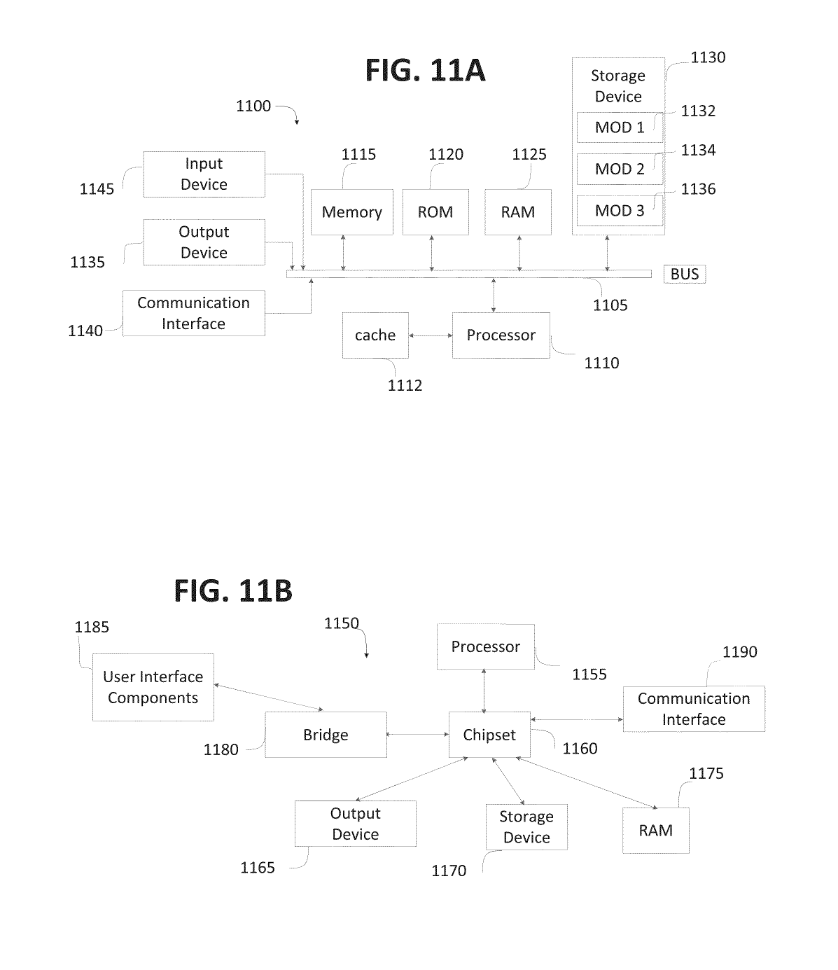

FIG. 11A and FIG. 11B illustrate example system embodiments. The more appropriate embodiment will be apparent to those of ordinary skill in the art when practicing the present technology. Persons of ordinary skill in the art will also readily appreciate that other system embodiments are possible.

FIG. 11A illustrates a conventional system bus computing system architecture 1100 wherein the components of the system are in electrical communication with each other using a bus 1105. Exemplary system 1100 includes a processing unit (CPU or processor) 1110 and a system bus 1105 that couples various system components including the system memory 1115, such as read only memory (ROM) 1170 and random access memory (RAM) 1175, to the processor 1110. The system 1100 can include a cache of high-speed memory connected directly with, in close proximity to, or integrated as part of the processor 1110. The system 1100 can copy data from the memory 1115 and/or the storage device 1130 to the cache 1112 for quick access by the processor 1110. In this way, the cache can provide a performance boost that avoids processor 1110 delays while waiting for data. These and other modules can control or be configured to control the processor 1110 to perform various actions. Other system memory 1115 may be available for use as well. The memory 1115 can include multiple different types of memory with different performance characteristics. The processor 1110 can include any general purpose processor and a hardware module or software module, such as module 1 1137, module 2 1134, and module 3 1136 stored in storage device 1130, configured to control the processor 1110 as well as a special-purpose processor where software instructions are incorporated into the actual processor design. The processor 1110 may essentially be a completely self-contained computing system, containing multiple cores or processors, a bus, memory controller, cache, etc. A multi-core processor may be symmetric or asymmetric.

To enable user interaction with the computing device 1100, an input device 1145 can represent any number of input mechanisms, such as a microphone for speech, a touch-sensitive screen for gesture or graphical input, keyboard, mouse, motion input, speech and so forth. An output device 1135 can also be one or more of a number of output mechanisms known to those of skill in the art. In some instances, multimodal systems can enable a user to provide multiple types of input to communicate with the computing device 1100. The communications interface 1140 can generally govern and manage the user input and system output. There is no restriction on operating on any particular hardware arrangement and therefore the basic features here may easily be substituted for improved hardware or firmware arrangements as they are developed.

Storage device 1130 is a non-volatile memory and can be a hard disk or other types of computer readable media which can store data that are accessible by a computer, such as magnetic cassettes, flash memory cards, solid state memory devices, digital versatile disks, cartridges, random access memories (RAMs) 1175, read only memory (ROM) 1180, and hybrids thereof.

The storage device 1130 can include software modules 1138, 1134, 1136 for controlling the processor 1110. Other hardware or software modules are contemplated. The storage device 1130 can be connected to the system bus 1105. In one aspect, a hardware module that performs a particular function can include the software component stored in a computer-readable medium in connection with the necessary hardware components, such as the processor 1110, bus 1105, display 1135, and so forth, to carry out the function.

FIG. 11B illustrates an example computer system 1150 having a chipset architecture that can be used in executing the described method and generating and displaying a graphical user interface (GUI). Computer system 1150 is an example of computer hardware, software, and firmware that can be used to implement the disclosed technology. System 1150 can include a processor 1155, representative of any number of physically and/or logically distinct resources capable of executing software, firmware, and hardware configured to perform identified computations. Processor 1155 can communicate with a chipset 1160 that can control input to and output from processor 1155. In this example, chipset 1160 outputs information to output 1165, such as a display, and can read and write information to storage device 1170, which can include magnetic media, and solid state media, for example. Chipset 1160 can also read data from and write data to RAM 1175. A bridge 1180 for interfacing with a variety of user interface components 1185 can be provided for interfacing with chipset 1160. Such user interface components 1185 can include a keyboard, a microphone, touch detection and processing circuitry, a pointing device, such as a mouse, and so on. In general, inputs to system 1150 can come from any of a variety of sources, machine generated and/or human generated.

Chipset 1160 can also interface with one or more communication interfaces 1190 that can have different physical interfaces. Such communication interfaces can include interfaces for wired and wireless local area networks, for broadband wireless networks, as well as personal area networks. Some applications of the methods for generating, displaying, and using the GUI disclosed herein can include receiving ordered datasets over the physical interface or be generated by the machine itself by processor 1155 analyzing data stored in storage 1170 or 1175. Further, the machine can receive inputs from a user via user interface components 1185 and execute appropriate functions, such as browsing functions by interpreting these inputs using processor 1155. It can be appreciated that example systems 1100 and 1150 can have more than one processor 1110 or be part of a group or cluster of computing devices networked together to provide greater processing capability.

For clarity of explanation, in some instances the present technology may be presented as including individual functional blocks including functional blocks comprising devices, device components, steps or routines in a method embodied in software, or combinations of hardware and software.

In some embodiments the computer-readable storage devices, mediums, and memories can include a cable or wireless signal containing a bit stream and the like. However, when mentioned, non-transitory computer-readable storage media expressly exclude media such as energy, carrier signals, electromagnetic waves, and signals per se.

Methods according to the above-described examples can be implemented using computer-executable instructions that are stored or otherwise available from computer readable media. Such instructions can comprise, for example, instructions and data which cause or otherwise configure a general purpose computer, special purpose computer, or special purpose processing device to perform a certain function or group of functions. Portions of computer resources used can be accessible over a network. The computer executable instructions may be, for example, binaries, intermediate format instructions such as assembly language, firmware, or source code. Examples of computer-readable media that may be used to store instructions, information used, and/or information created during methods according to described examples include magnetic or optical disks, flash memory, USB devices provided with non-volatile memory, networked storage devices, and so on.

Devices implementing methods according to these disclosures can comprise hardware, firmware and/or software, and can take any of a variety of form factors. Typical examples of such form factors include laptops, smart phones, small form factor personal computers, personal digital assistants, rackmount devices, standalone devices, and so on. Functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are means for providing the functions described in these disclosures.

Although a variety of examples and other information was used to explain aspects within the scope of the appended claims, no limitation of the claims should be implied based on particular features or arrangements in such examples, as one of ordinary skill would be able to use these examples to derive a wide variety of implementations. Further and although some subject matter may have been described in language specific to examples of structural features and/or method steps, it is to be understood that the subject matter defined in the appended claims is not necessarily limited to these described features or acts. For example, such functionality can be distributed differently or performed in components other than those identified herein. Rather, the described features and steps are disclosed as examples of components of systems and methods within the scope of the appended claims. Moreover, claim language reciting “at least one of” a set indicates that one member of the set or multiple members of the set satisfy the claim.

What is claimed is:

1. A touch-screen actuation pad configured to emulate an interaction with a touch-screen surface, the touch-screen actuation pad comprising:
an actuation layer comprising a matrix of transistors; and
a conductive layer comprising a plurality of conductive pads, wherein each conductive pad is electrically coupled with a respective transistor on the actuation layer, wherein the conductive layer is configured for provide an engagement between the plurality of conductive pads and the touch-screen surface, and
wherein each transistor is configured to transmit a driving signal to a corresponding conductive pad of the conductive layer to emulate an engagement with the touch-screen surface.

2. The touch-screen actuation pad of claim 1, wherein the transmission of the driving signal to the corresponding conductive pad of the conductive layer emulates the user engagement at the corresponding location of the touch screen.

3. The touch-screen actuation pad of claim 1, wherein the transmission of the driving signal to the corresponding conductive pad changes the capacitance of the corresponding conductive pad.

4. The touch-screen actuation pad of claim 1, further comprising:
a routing layer communicatively coupled between the actuation layer and the conductive layer, wherein the routing layer is configured to transmit a driving signal from a selected transistor to a corresponding conductive pad in the conductive layer.

5. The touch-screen actuation pad of claim 4, wherein the routing layer further comprises:
a first routing layer electrically coupled to the actuation layer; and
a second routing layer electrically coupled to the conductive layer and the first routing layer, wherein the first routing layer is configured to transmit the driving signal from each transistor of the actuation layer to the second routing layer, and wherein the second routing layer is configured to transmit the driving signal from the first routing layer to the conductive layer.

6. The touch-screen actuation pad of claim 1, further comprising:
a gesture detection device operatively communicating with the actuation layer and configured to detect a gesture.

7. The touch-screen actuation pad of claim 6, wherein the gesture detection device comprises one or more: cameras, motions detectors, or infrared sensor sensors.

8. The touch-screen actuation pad of claim 1, further comprising:
a near field communication (NFC) antenna operatively communicating with a processor, wherein the processor is configured to receive capacitive signaling from a secondary touch screen from the NFC antenna and based on the received capacitive signaling, control activation and deactivation of each transistor from the matrix of transistors.

9. The touch-screen actuation pad of claim 1, wherein the matrix of transistors comprises one or more transistors of the following type: MOSFET, FET, or BJT.

10. A method for emulating an interaction with a target touch-screen surface, the method comprising:
actuating one or more transistors in an actuator comprising a matrix of transistors, wherein actuation of the one or more transistors causes transmission of a driving signal to one or more conductive pads located on a target touch-screen surface for emulating a user's interaction with the target touch-screen surface at a corresponding location.

11. The method of claim 10, wherein the transmission of the driving signal to the corresponding conductive pad changes the capacitance of the corresponding conductive pad.

12. The method of claim 10, wherein the driving signal is transmitted by a routing layer electrically coupled between an actuation layer comprising the matrix of transistors and a conductive layer comprising the one or more conductive pads.

13. The method of claim 10, further comprising:
detecting a user's gesture, using a gesture detection device, wherein the gesture detection device is communicatively coupled with an actuation layer comprising the matrix of transistors.

14. The method of claim 13, wherein the gesture detection device comprises one or more: cameras, motions detectors, or infrared sensor sensors.

15. The method of claim 10, further comprising:
receiving capacitive signaling from a secondary touch screen via a near field communication (NFC) antenna.

16. The method of claim 10, wherein the matrix of transistors comprises one or more transistors of the following type: MOSFET, FET, or BJT.

17. The method of claim 10, further comprising:
receiving a user's touch input on a touch-screen of a converter tablet (CT) device,
wherein actuating the one or more transistors in the actuator, is based on the user's touch input.

18. The method of claim 10, wherein the CT device facilitates contact between the one or more conductive pads located on a touch-screen surface for emulating a user's interaction with the touch-screen surface at a corresponding location.
